(19) United States
(12) Patent Application Publication
(10) Pub. No.: US 2026/0155844 A1
(43) Pub. Date: Jun. 4, 2026

(54) METHOD FOR TRANSMITTER SUPPLY SWITCHING AND ARCHITECTURE FOR 5G NSA

(71) Applicant: SKYWORKS SOLUTIONS, INC., Irvine, CA (US)

(72) Inventor: David Richard Pehlke, Westlake Village, CA (US)

(21) Appl. No.: 19/277,556

(22) Filed: Jul. 23, 2025

Related U.S. Application Data
(60) Provisional application No. 63/676,006, filed on Jul. 26, 2024.

(51) Int. Cl. H04B 1/00; H04B 1/04

(52) U.S. Cl. CPC H04B 1/006; H04B 1/04; H04B 2001/0408

(57) ABSTRACT

According to at least one aspect of the present disclosure, a wireless device is provided comprising a first voltage pad configured to be coupled to a source of a first voltage, a second voltage pad configured to be coupled to a source of a second voltage, a band-select switch having a first input and a second input, and a power amplifier including a first cascade switch coupled to the first voltage pad and the first input of the band-select switch, and a second cascade switch coupled to the second voltage pad and the second input of the band-select switch.

### CROSS-REFERENCE TO RELATED APPLICATIONS

This application claims priority under 35 U.S.C. § 119 (e) to U.S. Provisional Patent Application Ser. No. 63/676,006, titled “METHOD FOR TRANSMITTER SUPPLY SWITCHING AND ARCHITECTURE FOR 5G NSA,” filed Jul. 26, 2024, the contents of which are incorporated herein in its entirety for all purposes.

### BACKGROUND

### 1. Field of the Disclosure

At least one example in accordance with the present disclosure relates generally to power supplies for power amplifier modules.

### 2. Discussion of Related Art

Electronic devices, such as mobile cellular devices, may exchange information with other electronic devices. A mobile cellular device may include an antenna to transmit and receive signals. Mobile cellular devices may include additional components and circuitry to process signals transmitted and received via the antenna. For example, a mobile cellular device may include one or more power amplifiers to amplify a signal transmitted or received via the antenna.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description.

References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B-that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

According to at least one aspect of the present disclosure, a wireless device is provided comprising a first voltage pad configured to be coupled to a source of a first voltage, a second voltage pad configured to be coupled to a source of a second voltage, a band-select switch having a first input and a second input, and a power amplifier including a first cascade switch coupled to the first voltage pad and the first input of the band-select switch, and a second cascade switch coupled to the second voltage pad and the second input of the band-select switch.

In at least one example, the power amplifier further comprises a radio-frequency (RF) switch coupled to the first cascade switch and the second cascade switch. In at least one example, the RF switch includes a first connection coupled to the first cascade switch and the second cascade switch and a second connection coupled to a reference node. In at least one example, the RF switch is a bipolar junction transistor (BJT) and wherein the first connection is a collector and the second connection is an emitter. In at least one example, the RF switch includes a base configured to receive an RF signal. In at least one example, the first cascade switch is a BJT having a collector coupled to the first input of the band-select switch and an emitter coupled to the collector of the RF switch. In at least one example, the second cascade switch is a BJT having a collector coupled to the second input of the band-select switch and an emitter coupled to the collector of the RF switch.

In at least one example, the first cascade switch is a bipolar junction transistor (BJT) having a collector coupled to the first input of the band-select switch and an emitter. In at least one example, the second cascade switch is a BJT having a collector coupled to the second input of the band-select switch and an emitter. In at least one example, the first voltage pad is configured to receive a first voltage and the second voltage pad is configured to receive a second voltage different than the first voltage.

According to at least one example of the disclosure, a power amplifier is provided comprising a first cascade switch configured to be coupled to a first power source and to a first input of a band-select switch, a second configured to be coupled to a second power source and to a second input of the band-select switch, and a radio-frequency (RF) switch configured to be coupled to the first cascade switch and the second cascade switch.

In at least one example, the RF switch is a bipolar junction transistor (BJT) having a collector configured to be coupled to the first cascade switch and the second cascade switch. In at least one example, the RF switch includes an emitter configured to be coupled to a reference node. In at least one example, the RF switch includes a base configured to receive an RF signal from a transceiver. In at least one example, the first cascade switch is a BJT having an emitter configured to be coupled to the collector of the RF switch. In at least one example, the second cascade switch is a BJT having an emitter configured to be coupled to the collector of the RF switch. In at least one example, the first cascade switch includes a collector configured to be coupled to the first power source and to the first input of the band-select switch. In at least one example, the second cascade switch includes a collector configured to be coupled to the second power source and to the second input of the band-select switch.

According to at least one example, a method of operating a wireless device is provided comprising a first voltage pad configured to be coupled to a source of a first voltage, a second voltage pad configured to be coupled to a source of a second voltage, a band-select switch having a first input and a second input, and a power amplifier including a first cascade switch coupled to the first voltage pad and the first input of the band-select switch, a second cascade switch coupled to the second voltage pad and the second input of the band-select switch, and a radio-frequency (RF) switch coupled to the first cascade switch and the second cascade switch, the method comprising receiving, by the RF switch, a first transmit signal, operating the first cascade switch and the RF switch to draw power from the first voltage pad and amplify the first transmit signal to produce a first amplified signal, providing the first amplified signal to the first input of the band-select switch, receiving, by the RF switch, a second transmit signal, operating the second cascade switch and the RF switch to draw power from the second voltage pad and amplify the second transmit signal to produce a second amplified signal, and providing the second amplified signal to the second input of the band-select switch.

In at least one example, the method includes receiving, by the RF switch, a third transmit signal, operating the first cascade switch, the second cascade switch, and the RF switch to draw power from the first voltage pad and the second voltage pad and amplify the third transmit signal to produce a third amplified signal, and providing the third amplified signal to at least one of the first input or the second input of the band-select switch.

### BRIEF DESCRIPTION OF THE DRAWINGS

Various aspects of at least one embodiment are discussed below with reference to the accompanying figures, which may not be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or substantially similar component that is illustrated in various figures may be represented by a like numeral. For purposes of clarity, not every component may be labeled in every figure. In the figures:

FIG. 1 illustrates a block diagram of a wireless device according to an example;

FIG. 2 illustrates a block diagram of a power amplifier with integrated duplexer according to an example;

FIG. 3 illustrates a block diagram of a portion of a wireless device according to an example;

FIG. 4 illustrates a schematic diagram of one example of a portion of a wireless device according to an example; and

FIG. 5 illustrates a schematic diagram of another example of a portion of a wireless device according to an example

### DETAILED DESCRIPTION

Some wireless electronic devices, such as smartphones, exchange wireless communication signals with other electronic devices. Wireless devices may include antennas configured to send (and, in some examples, receive) wireless signals, and power amplifiers to amplify the wireless signals prior to transmission. Some devices may further include a band-select system to select which frequency band over which to send communications.

Examples of the disclosure include a power-supply system for a power amplifier and a band-select switch. In at least one example, the band-select switch is implemented directly on a power-amplifier-switch collector to select an active antenna array and supply. In various examples, the system is implemented at high voltages (for example, 11 V) which presents high impedances (for example, 50 Ohms) to enable the described topologies by minimizing switch currents and/or I²R losses. These high impedances may enable additional beneficial operation modes, such as by enabling both of two power-amplifier switches to be active in a multi-on mode.

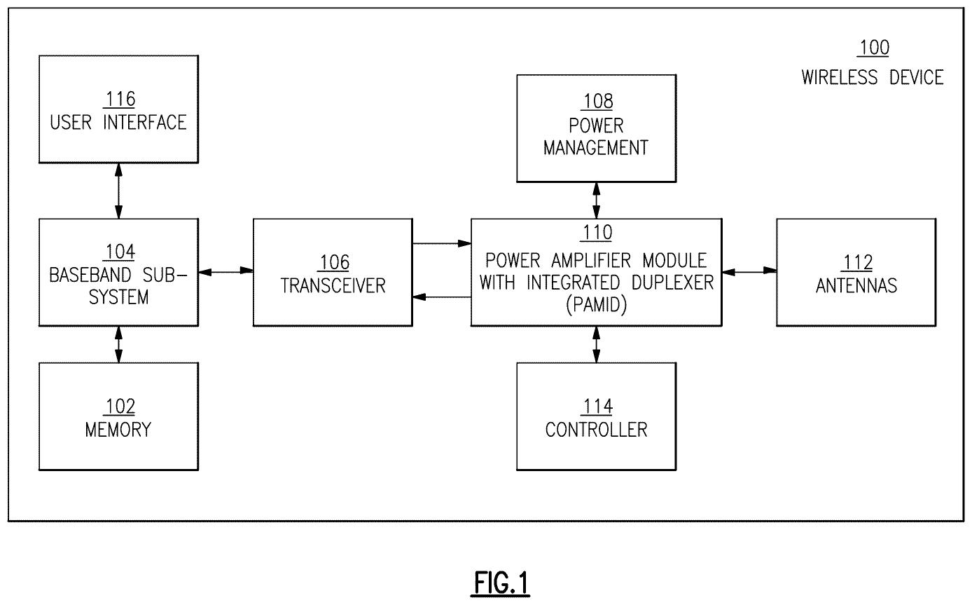

FIG. 1 illustrates a block diagram of a wireless device 100 according to an example. For purposes of example, the wireless device 100 may be a smartphone device; however, the principles of the disclosure are not limited to smartphones and are applicable at least to any devices sending wireless communications. The wireless device 100 includes a user interface 116, a memory and/or storage 102 (“memory 102”), a baseband sub-system 104, a transceiver 106, a power-management system 108, a power-amplifier module with integrated duplexer (PAMID) 110 (also referred to as a power amplifier with integrated duplexer, or PAID), one or more antennas 112 (“antennas 112”), and one or more controllers 114 (“controller 114”).

The user interface 116 is coupled to the baseband sub-system 104. The memory 102 is coupled to the baseband sub-system 104. The baseband sub-system 104 is coupled to the user interface 116, the memory 102, and the transceiver 106. The transceiver 106 is coupled to the baseband sub-system 104 and the PAMID 110. The power-management system 108 is coupled to the PAMID 110 and, in some examples, other components such as the transceiver 106. The PAMID 110 is coupled to the transceiver 106, the power-management system 108, the antennas 112, and the controller 114. The antennas 112 are coupled to the PAMID 110 and are configured to be communicatively coupled to at least one external device, such as a base station. The controller 114 is coupled to the PAMID 110.

The wireless device 100 may include additional, different, or rearranged components in some examples. Illustrated components and connections therebetween are provided for purposes of explanation and are not intended to be limiting. The wireless device 100 may include different components with different connections in alternate examples.

The antennas 112 are configured to transmit and/or receive one or more signals, such that the wireless device 100 may communicate with one or more external devices via the antennas 112. For example, the antennas 112 may be communicatively coupled to at least one base station. The transceiver 106 is configured to generate signals for transmission and/or to process received signals. In some embodiments, transmission and reception functionalities can be implemented in separate components (for example, a transmit module and a receiving module) or be implemented in the same module.

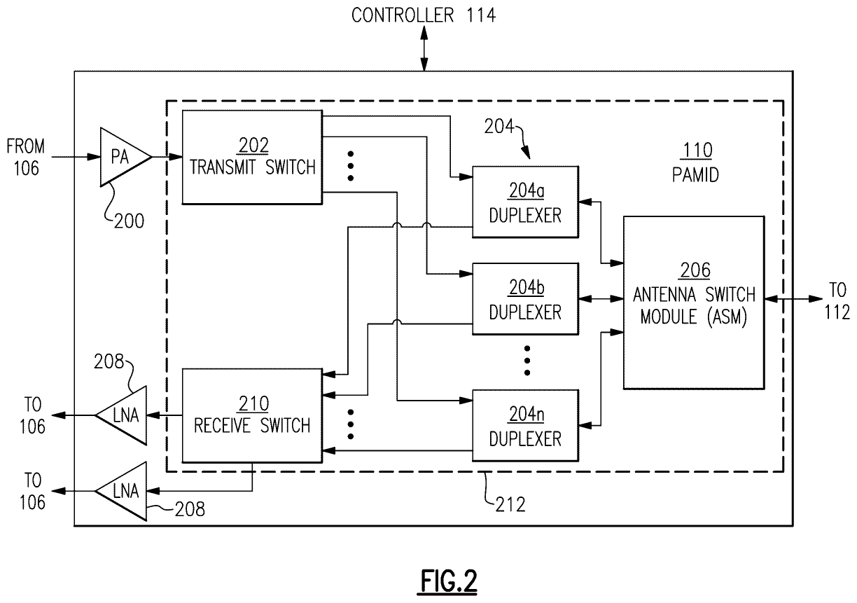

Signals generated for transmission are provided from the transceiver 106 to the PAMID 110, which amplifies the generated signals from the transceiver 106. As will be appreciated by those skilled in the art, the PAMID 110 can include one or more power amplifiers, switches, duplexers, antenna switch modules, band-select switches, and so forth, as discussed below with respect to FIG. 2. The PAMID 110 can be used to amplify a wide variety of radio-frequency (RF) or other frequency-band transmission signals. For example, the PAMID 110 can receive an enable signal that can be used to pulse the output of a power amplifier to aid in transmitting a wireless local-area-network (WLAN) signal or any other suitable pulsed signal. The PAMID 110 can be configured to amplify any of a variety of types of signals, including, for example, 5G signals, a Global System for Mobile (GSM) signal, a code-division multiple-access (CDMA) signal, a W-CDMA signal, a Long-Term-Evolution (LTE) signal, an EDGE signal, and so forth. In certain examples, the PAMID 110 and associated components including switches and the like can be fabricated on GaAs substrates using, for example, pHEMT or BiFET transistors, or on a silicon substrate using CMOS transistors. The PAMID 110 may further include one or more low-noise amplifiers (LNAs) configured to amplify received signals in a similar or different manner as the PAs of the PAMID 110.

In some examples, the PAMID 110 may include, or be coupled to, one or more couplers. The one or more couplers may each include one or more coupler sections for measuring transmitted power signals from the PAMID 110 and/or for providing one or more coupled signals to the transceiver 106. For example, the PAMID 110 may include, or be coupled to, one or more sensors configured to receive information from the one or more couplers and provide information to the transceiver 106, power-management system 108, and/or other components. The information may be used to, for example, regulate the power level of one or more PAS and/or LNAs in the PAMID 110. In this way the one or more couplers can be used to boost and/or decrease the power of a transmission signal having a relatively low or high power. However, the one or more couplers can be used in a variety of other implementations.

As discussed above, the PAMID 110 may be configured to route transmit and/or receive signals between the transceiver 106 and the antennas 112. FIG. 2 illustrates a block diagram of the PAMID 110 according to one example. The PAMID 110 includes one or more PAs 200 (“PA 200”), a transmit switch 202, an arbitrary number of duplexers 204, an antenna switch module (ASM) 206, one or more LNAs 208 (“LNAs 208”), and one or more receive switches 210 (“receive switch 210”). The transmit switch 202, the duplexers 204, the ASM 206, and the receive switch 210 may collectively be referred to as a band-select system 212. Certain connections of the PAMID 110, such as power-supply connections to one or more components of the PAMID 110 (including, for example, to the PA 200) are omitted for clarity.

The PA 200 has an input configured to be coupled to the transceiver 106, and an output coupled to the transmit switch 202. An impedance presented to the PA 200 may depend on a transmit path between the PA 200 and the antennas 112 which may, in turn, depend on a state of the transmit switch 202 and a state of the ASM 206. The transmit switch 202 includes an input coupled to the PA 200 and an arbitrary number of outputs each coupled to a respective duplexer of the duplexers 204. Each of the duplexers 204 includes an input coupled to the transmit switch 202, an output coupled to the receive switch 210, and an input/output coupled to the ASM 206.

The ASM 206 includes an arbitrary number of input/outputs each coupled to a respective duplexer of the duplexers 204, and an input/output coupled to the antennas 112. The LNAs 208 each include an output configured to be coupled to the transceiver 106, and an input coupled to the receive switch 210. In some examples, each of the LNAs 208 includes an input coupled to a respective receive switch of the receive switch 210. For example, the LNAs 208 may include two LNAs and the receive switch 210 may include two receive switches, where each LNA includes an input coupled to a respective one of the two receive switches. The receive switch 210 includes an arbitrary number of inputs each coupled to a respective duplexer of the duplexers 204, and an output coupled to the LNA 208.

FIG. 2 illustrates one example of the PAMID 110. In various examples, alternate or additional components, and/or connections therebetween, of the PAMID 110 may be implemented. For example, in some examples the PAMID 110 may include one or more filters, one or more switching devices, one or more couplers (for example, coupled to the ASM 206), one or more clocks, one or more power-supply components, and so forth, which are omitted for purposes of clarity.

As discussed above, the PAMID 110 is configured to transmit and/or receive one or more signals between the transceiver 106 and antennas 112. For example, a transmit signal received at the PA 200 from the transceiver 106 may be amplified and provided to the transmit switch 202. The transmit switch 202 may route the transmit signal to a desired one of the duplexers 204. As appreciated by one of ordinary skill in the art, a duplexer may be considered analogous to a frequency selective switch and enables bi-directional communication over a single antenna channel by isolating a transmitter from a receiver. Each of the duplexers 204 may correspond to a respective frequency band. Accordingly, the transmit switch 202 may route the transmit signal to a duplexer corresponding to the frequency band of the transmit signal.

In one example, a state of the transmit switch 202 (for example, corresponding to which of the duplexers 204 the transmit switch 202 couples to the PA 200) is controlled by the controller 114 and/or another control device. For example, the controller 114 may control the state of the transmit switch 202 based on a frequency band of the transmit signal. For purposes of example, the transmit switch 202 may route the transmit signal to a first duplexer 204a because the first duplexer 204a corresponds to a frequency band of the transmit signal. The first duplexer 204a receives the transmit signal and provides the transmit signal to the ASM 206. The ASM 206 is configured to route the transmit signal to the antennas 112, which transmits the transmit signal to a receiving entity (for example, a base station). In some examples, a state of the ASM 206 is controlled by the controller 114.

In another example, a receive signal is received at the ASM 206 from the antennas 112. The ASM 206 routes the receive signal to an appropriate one of the duplexers 204. For example, the ASM 206 may route the receive signal to a duplexer corresponding to the frequency band of the receive signal. The controller 114 may control a state of the ASM 206. As discussed in greater detail below, the controller 114 may control the state of the ASM 206 during carrier aggregation based on a state of the transmit switch 202. For purposes of example, the ASM 206 may route the receive signal to a second duplexer 204b. The second duplexer 204b provides the receive signal to the receive switch 210. The receive switch 210 provides the receive signal to the LNA 208. The LNA 208 amplifies the receive signal and is configured to provide the amplified signal to the transceiver 106.

As discussed above, power-management-unit (PMU) connectivity may not be explicitly shown in FIG. 2 for clarity of illustration. However, PMU connectivity may be implemented for each transmit path to supply power and/or DC current for the transmit function of the wireless device 100. For example, supply power and/or DC current may be provided to the PA 200 to support transmit functionality. PMU connectivity may also be implemented for each receive path, including by providing supply power and/or DC current to the LNAs 208; however, for simplicity rather than limitation, the following discussion may focus on supply power to the PA 200.

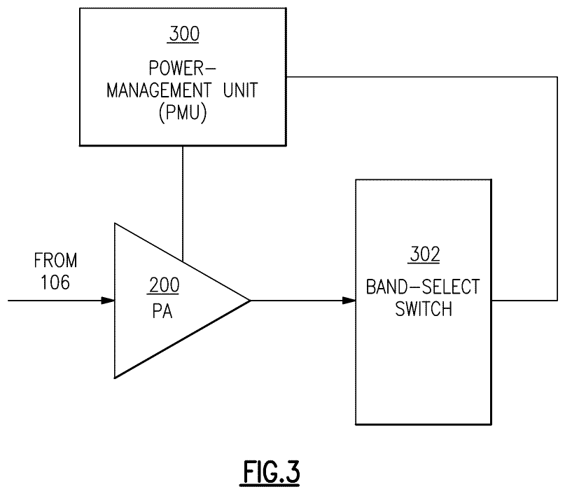

FIG. 3 illustrates a block diagram of a portion of the wireless device 100 according to an example. FIG. 3 includes the PA 200, a power-management unit 300, and a band-select switch 302. The power-management unit (PMU) 300 may be at least a portion of the power-management system 108. The band-select switch 302 may be at least a portion of the band-select system 212. For example, the band-select switch 302 may include the transmit switch 202, one or more of the duplexers 204, and/or the ASM 206.

The PMU 300 may illustrate only a portion of the power-management system 108 for clarity of illustration; for example, the power-management system 108 may also include power-supply components to provide power to the LNAs 208, which are omitted for clarity. Similarly, the band-select switch 302 may illustrate only a portion of the band-select system 212 for clarity of illustration; for example, the band-select system 212 may also include connections (for example, input and/or output connections) to couple to the LNAs 208 and/or the antennas 112, which are omitted for clarity.

The PA 200 receives a transmit signal from the transceiver 106, amplifies the transmit signal, and provides the amplified signal to the band-select switch 302. The band-select switch 302 may route the amplified signal to the antennas 112. For example, the band-select switch 302 may select which frequency band to transmit signals over, and select that frequency band by routing a transmit path corresponding to that frequency band to the antennas 112.

The PMU 300 may provide power to the PA 200 and/or the band-select switch 302. For example, the PMU 300 may provide supply power and DC current to the PA 200 for the signal-transmission function. Different signal-transmission approaches implemented by the PA 200, such as average power tracking (APT) and envelope tracking (ET), may require different supply voltages. For example, if the PA 200 executes APT, the PA 200 may require fixed-voltage supply power from the PMU 300. If the PA 200 executes ET, the PA 200 may require modulated-voltage supply power from the PMU 300. Accordingly, the PMU 300 may supply various different supply voltages to the PA 200 and/or the band-select switch 302.

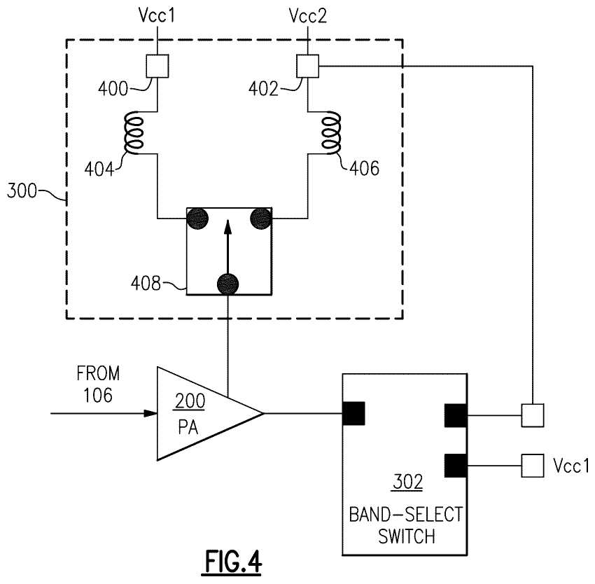

FIG. 4 illustrates a schematic diagram of one example of the PMU 300 providing supply power to the PA 200. In the illustrated example, the PMU 300 includes a first voltage pad 400, a second voltage pad 402, a first inductive element 404, a second inductive element 406, and a switch 408. In at least one example, the switch 408 includes a single-pole, double-throw switch.

The PA 200 is coupled to the transceiver 106 at an input, is coupled to the band-select switch 302 at an output, and is coupled to the switch 408 at a power-supply input. The band-select switch 302 is coupled to the PA 200 at a first connection, is coupled to the first voltage pad 400 at a second connection, and is coupled to the second voltage pad 402 at a third connection. The band-select switch 302 may also be coupled to additional components, such as the antennas 112 and/or the LNAs 208, which are omitted for clarity.

The first voltage pad 400 is coupled to the first inductive element 404 and the band-select switch 302 and is configured to be coupled to a source of a first voltage Vcc₁. The second voltage pad 402 is coupled to the second inductive element 406 and the band-select switch 302 and is configured to be coupled to a source of a second voltage Vcc₂. The first inductive element 404 is coupled to the first voltage pad 400 at a first connection and is configured to be coupled to the switch 408 at a second connection. The second inductive element 406 is coupled to the second voltage pad 402 at a first connection and is configured to be coupled to the switch 408 at a second connection.

The switch 408 is switchably coupled to the first inductive element 404 at a first connection, is switchably coupled to the second inductive element 406 at a second connection, and is coupled to the PA 200 at a third connection. The switch 408 is configured to switchably couple either the first voltage pad 400 (via the first inductive element 404) or the second voltage pad 402 (via the second inductive element 406) to the PA 200 to provide power to the PA 200. The controller 114 may be coupled to the switch 408 and may control the switching state of the switch 408.

The PA 200 may therefore receive a transmit signal from the transceiver 106, amplify the transmit signal according to a desired gain based on the supply voltage received via the switch 408, and provide the amplified signal to the band-select switch 302. The band-select switch 302 may route the amplified transmit signal to the antennas 112.

In various examples, however, the PA 200 may require an impedance transformation network before the band-select switch 302 to manage switching losses. I²R losses may be high for transmit signals at lower voltages, particularly if an impedance transformation network is not implemented. Accordingly, the example of FIG. 4 may experience relatively high losses for certain transmit signals.

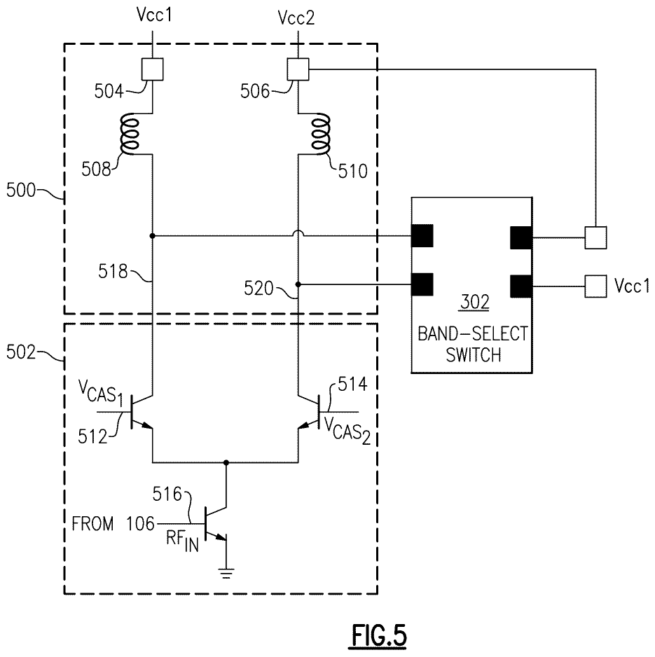

FIG. 5 illustrates a schematic diagram of another example of a PMU 500 providing supply power to a PA 502. The PMU 500 may be an example of the PMU 300. The PA 502 may be an example of the PA 200. In the illustrated example, the PMU 500 includes a first voltage pad 504, a second voltage pad 506, a first inductive element 508, and a second inductive element 510. The PA 502 includes a first cascade switch 512, a second cascade switch 514, and a radio-frequency switch 516 (“RF switch 516”). The first and second cascade switches 512, 514 may be an output stage of the power amplifier 502.

The first voltage pad 504 is coupled to the first inductive element 508 and the band-select switch 302 and is configured to be coupled to a source of a first voltage Vcc₁. The second voltage pad 506 is coupled to the second inductive element 510 and the band-select switch 302 and is configured to be coupled to a source of a second voltage Vcc₂. The first inductive element 508 is coupled to the first voltage pad 504 at a first connection and is coupled to the band-select switch 302 and the first cascade switch 512 at a second connection. The second inductive element 510 is coupled to the second voltage pad 506 at a first connection and is coupled to the band-select switch 302 and the second cascade switch 514 at a second connection.

The first cascade switch 512 is coupled to the first inductive element 508 and the band-select switch 302 at a first connection and is coupled to the RF switch 516 at a second connection. In some examples, the first cascade switch 512 is configured to be coupled to a source of a voltage Vcas₁ and/or to the controller 114 at a control connection. In at least one example, the first cascade switch 512 may be a bipolar junction transistor (BJT), and the first connection may be a collector, the second connection may be an emitter, and the control connection may be a base.

The second cascade switch 514 is coupled to the second inductive element 510 and the band-select switch 302 at a first connection and is coupled to the RF switch 516 at a second connection. In some examples, the second cascade switch 514 is configured to be coupled to a source of a voltage Vcas₂ and/or to the controller 114 at a control connection. In at least one example, the second cascade switch 514 may be a BJT, and the first connection may be a collector, the second connection may be an emitter, and the control connection may be a base.

The RF switch 516 is coupled to the cascade switches 512, 514 at a first connection, is coupled to a reference node (for example, a ground node) at a second connection, and is configured to be coupled to the transceiver 106 and/or the controller 114 at a control connection. In at least one example, the RF switch 516 may be a BJT, and the first connection may be a collector, the second connection may be an emitter, and the control connection may be a base.

The band-select switch 302 includes a first connection configured to be coupled to a first node 518 between the first inductive element 508 and the first cascade switch 512, a second connection configured to be coupled to a second node 520 between the second inductive element 510 and the second cascade switch 514, a third connection configured to be coupled to the first voltage pad 504, and a fourth connection configured to be coupled to the second voltage pad 506.

Accordingly, in examples in which the cascade switches 512, 514 are BJTs having collectors coupled to the nodes 518, 520, respectively, the band-select switch 302 may be coupled directly to the collectors of the cascade switches 512, 514. In high-voltage (for example, approximately 11 V) applications, an impedance at the nodes 518, 520 may be particularly high (for example, approximately 50 Ohms) to enable this configuration.

Either or both of the cascade switches 512, 514 may be operated depending on a selected transmit channel. A transmit channel may be selected between a first transmit channel via the first cascade switch 512 or a second transmit channel via the second cascade switch 514. A transmit channel may be selected based on a desired supply voltage, that is, Vcc₁ for the first transmit channel and Vcc₂ for the second transmit channel. As discussed above, different supply voltages may be desirable for different power-amplification schemes, such as APT and ET.

In some examples, both of the cascade switches 512, 514 may be activated for high-power operation. That is, rather than using only one of the transmit channels, both transmit channels may be activated. At lower voltages, this multi-ON configuration may yield disadvantageously high impedances which may lead to large switch currents and/or I²R losses.

Accordingly, by having two separate cascade stages as illustrated in FIG. 5, the band-select switch 302 may select an output stage and power supply domain without adversely impacting efficiency. In various examples, multiple power supplies may be leveraged to provide power combining and much higher power (for example, greater than 3 dB) capabilities by using both of the cascade stages concurrently as an additional high-efficiency gain mode.

Various controllers, such as the controller 114, may execute various operations discussed above. The controller 114 may be or include one or more hardware components and may be or include processing circuitry. The controller 114 may also execute one or more instructions stored on one or more non-transitory computer-readable media, which the controller 114 may include and/or be coupled to, which may result in manipulated data. The one or more non-transitory computer-readable media may be or include hardware devices. The non-transitory computer-readable media may include memory and/or storage hardware. In some examples, the controller 114 may include one or more processors or other types of controllers. In one example, the controller 114 is or includes at least one processor. Example processors may include hardware components such as microprocessors. In another example, the controller 114 performs at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above. The computer-program product may be, or include, at least one hardware component configured to store and/or execute at least one computer program, and may be or include processing circuitry.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A wireless device comprising:
a first voltage pad configured to be coupled to a source of a first voltage;
a second voltage pad configured to be coupled to a source of a second voltage;
a band-select switch having a first input and a second input; and
a power amplifier including
a first cascade switch coupled to the first voltage pad and the first input of the band-select switch, and
a second cascade switch coupled to the second voltage pad and the second input of the band-select switch.

2. The wireless device of claim 1 wherein the power amplifier further comprises a radio-frequency (RF) switch coupled to the first cascade switch and the second cascade switch.

3. The wireless device of claim 2 wherein the RF switch includes a first connection coupled to the first cascade switch and the second cascade switch and a second connection coupled to a reference node.

4. The wireless device of claim 3 wherein the RF switch is a bipolar junction transistor and wherein the first connection is a collector and the second connection is an emitter.

5. The wireless device of claim 4 wherein the RF switch includes a base configured to receive an RF signal.

6. The wireless device of claim 5 wherein the first cascade switch is a bipolar junction transistor having a collector coupled to the first input of the band-select switch and an emitter coupled to the collector of the RF switch.

7. The wireless device of claim 6 wherein the second cascade switch is a bipolar junction transistor having a collector coupled to the second input of the band-select switch and an emitter coupled to the collector of the RF switch.

8. The wireless device of claim 1 wherein the first cascade switch is a bipolar junction transistor having a collector coupled to the first input of the band-select switch and an emitter.

9. The wireless device of claim 6 wherein the second cascade switch is a bipolar junction transistor having a collector coupled to the second input of the band-select switch and an emitter.

10. The wireless device of claim 1 wherein the first voltage pad is configured to receive a first voltage and the second voltage pad is configured to receive a second voltage different than the first voltage.

11. A power amplifier comprising:
a first cascade switch configured to be coupled to a first power source and to a first input of a band-select switch;
a second cascade switch configured to be coupled to a second power source and to a second input of the band-select switch; and
a radio-frequency (RF) switch configured to be coupled to the first cascade switch and the second cascade switch.

12. The power amplifier of claim 11 wherein the RF switch is a bipolar junction transistor having a collector configured to be coupled to the first cascade switch and the second cascade switch.

13. The power amplifier of claim 12 wherein the RF switch includes an emitter configured to be coupled to a reference node.

14. The power amplifier of claim 13 wherein the RF switch includes a base configured to receive an RF signal from a transceiver.

15. The power amplifier of claim 12 wherein the first cascade switch is a bipolar junction transistor having an emitter configured to be coupled to the collector of the RF switch.

16. The power amplifier of claim 15 wherein the second cascade switch is a bipolar junction transistor having an emitter configured to be coupled to the collector of the RF switch.

17. The power amplifier of claim 16 wherein the first cascade switch includes a collector configured to be coupled to the first power source and to the first input of the band-select switch.

18. The power amplifier of claim 17 wherein the second cascade switch includes a collector configured to be coupled to the second power source and to the second input of the band-select switch.

19. A method of operating a wireless device comprising a first voltage pad configured to be coupled to a source of a first voltage, a second voltage pad configured to be coupled to a source of a second voltage, a band-select switch having a first input and a second input, and a power amplifier including a first cascade switch coupled to the first voltage pad and the first input of the band-select switch, a second cascade switch coupled to the second voltage pad and the second input of the band-select switch, and a radio-frequency (RF) switch coupled to the first cascade switch and the second cascade switch, the method comprising:
receiving, by the RF switch, a first transmit signal;
operating the first cascade switch and the RF switch to draw power from the first voltage pad and amplify the first transmit signal to produce a first amplified signal;
providing the first amplified signal to the first input of the band-select switch;
receiving, by the RF switch, a second transmit signal;
operating the second cascade switch and the RF switch to draw power from the second voltage pad and amplify the second transmit signal to produce a second amplified signal; and
providing the second amplified signal to the second input of the band-select switch.

20. The method of claim 19 further comprising
receiving, by the RF switch, a third transmit signal,
operating the first cascade switch, the second cascade switch, and the RF switch to draw power from the first voltage pad and the second voltage pad and amplify the third transmit signal to produce a third amplified signal, and
providing the third amplified signal to at least one of the first input or the second input of the band-select switch.
